(19) United States
(12) Patent Application Publication
(10) Pub. No.: US 2017/0124181 A1
(43) Pub. Date: May 4, 2017

(54) AUTOMATIC FUZZY MATCHING OF ENTITIES IN CONTEXT

(71) Applicant: Oracle International Corporation, Redwood Shores, CA (US)

(72) Inventors: Fabrice Nauze, Amsterdam (NL); Sergiu Nisioi, Bucharest (RO)

(73) Assignee: Oracle International Corporation, Redwood Shores, CA (US)

(21) Appl. No.: 14/927,862

(22) Filed: Oct. 30, 2015

(51) Int. Cl. G06F 17/30

(52) U.S. Cl. CPC G06F 17/30613; G06F 17/30657; G06F 17/30616

(57) ABSTRACT

Embodiments of the invention provide systems and methods for processing of a text string. More specifically, embodiments of the present invention provide for contextual, fuzzy recognition of text strings such as, for example, product or company names in user queries to an automated virtual assistant or search service. The recognition can be consider contextual as it can function even when the string is embedded, e.g., in a larger sentence, and it can be considered fuzzy as it does not require a perfect match with the catalog of strings or lists of entities available. Embodiments can also define the appropriate reaction of the automated system to ambiguous matches. Embodiments couple the identification of one or more ambiguous references to entities in text queries to a topic identifier and adapt the response of the automated system depending on the occurrence of ambiguous references.

### BACKGROUND OF THE INVENTION

Embodiments of the present invention relate generally to methods and systems for processing of a text string and more particularly to performing comprehensive, fuzzy matching of tokens from a text string to one or more lists.

Automated systems such as search engines, virtual assistants, etc. commonly interact with human users or operators. In such systems, a user provides a query or other input that is intended to address a certain need or that contains one or more references to certain items (i.e., the topic). For example, a Customer Relationship Management (CRM) system can receive though a web page or other user interface text strings referring to products or services (commonly referred to as entities). The automated system will typically maintain or have access to a catalog or list of entities, e.g., products or services supported by the CRM system. For example, the list of entities might be defined by content owners in order to comply with marketing and editorial requirements or might be generated from other sources. However, the reference to those entities in the user query can be ambiguous. For example, the input may contain spelling errors or, for some other reason, may not exactly match an entry in the list of entities.

Solutions have been proposed to this kind of problem. One solution is to present end-users a dedicated entity/product search solution. That is, a dedicated search appliance can be provided to search only within a list of entities. This solution can address the issue of uniquely and precisely identifying entities but is not suitable in the more flexible or open context of text/online queries. Another solution is to give the ability to content owners of the automated system to manually define synonyms for entities in the entity lists. Given the possible large size of such lists this solution is highly time consuming, is not really scalable, and does not help to resolve ambiguities. Hence, there is a need for improved methods and systems for matching of tokens from a text string to one or more lists.

### BRIEF SUMMARY OF THE INVENTION

Embodiments of the invention provide systems and methods for performing comprehensive, fuzzy matching of tokens from a text string to one or more lists. According to one embodiment, matching tokens from a received text string to one or more lists can comprise storing a plurality of entity definitions in one or more lists of entities based on a catalog of tokens and generating an index of the one or more lists of entities. The index can map each token of the catalog to entity definitions in the one or more lists. The text string can comprise a plurality of characters forming one or more input tokens. The one or more input tokens in the text string can be identified and a plurality of likely entities corresponding to the text string can be determined based on the identified one or more input tokens and the index of the one or more lists of entities.

Determining the plurality of likely entities corresponding to the text string can further comprise determining whether a token of the one or more input tokens appears in the index of the one or more entities. In response to determining the token of the one or more input tokens appears in the index of the one or more entities, candidate entities can be retrieved from the one or more lists of entities based on the index. Determining whether a token of the one or more input tokens appears in the index of the one or more entities and retrieving candidate entities from the one or more lists of entities based on the index can be repeated for each identified one or more input tokens. Determining the plurality of likely entities corresponding to the text string can further comprise determining whether two or more tokens of the input tokens are neighboring tokens and, in response to determining two tokens of the input tokens are neighboring tokens, determining an intersection of the retrieved candidate entities for the two tokens of the input tokens and defining result entities as the intersection of the retrieved candidate entities for the two tokens of the input tokens. In response to determining two tokens of the input tokens are not neighboring tokens, result entities can be defined as the retrieved candidate entities for the two tokens of the input tokens.

Determining the plurality of likely entities corresponding to the text string can further comprise scoring the retrieved candidate entities using a similarity measure for each candidate entity and selecting one or more likely entities from the scored candidate entities based on the score of each candidate entity. Scoring the retrieved candidate entities using a similarity measure for each candidate entity can comprise comparing each candidate entity against the text string or comparing each candidate entity against one or more maximal windows of non-empty intersections within tokens of the candidate entities. The one or more likely entities corresponding to the text string can then be provided for further processing.

### BRIEF DESCRIPTION OF THE DRAWINGS

FIG. 1 is a block diagram illustrating components of an exemplary distributed system in which various embodiments of the present invention may be implemented.

FIG. 2 is a block diagram illustrating components of a system environment by which services provided by embodiments of the present invention may be offered as cloud services.

FIG. 3 is a block diagram illustrating an exemplary computer system in which embodiments of the present invention may be implemented.

FIG. 4 is a block diagram illustrating, at a high-level, functional components of a system for performing comprehensive, fuzzy matching of tokens from a text string to one or more lists according to one embodiment of the present invention.

FIG. 5 is a flowchart illustrating a process for performing comprehensive, fuzzy matching of tokens from a text string to one or more lists according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for processing of a text string. More specifically, embodiments of the present invention provide for contextual, fuzzy recognition of text strings such as, for example, product or company names in user queries to an automated virtual assistant or search service. The recognition can be consider contextual as it can function even when the string is embedded, e.g., in a larger sentence, and it can be considered fuzzy as it does not require a perfect match with the catalog of strings or lists of entities available. Embodiments can also define the appropriate reaction of the automated system to ambiguous matches. Embodiments couple the identification of one or more ambiguous references to entities in text queries to a topic identifier and adapt the response of the automated system depending on the occurrence of ambiguous references. This reduces the amount of work needed for content owners to curate their catalog of entities and enables a more natural interaction with the automated system. Various additional details of embodiments of the present invention will be described below with reference to the figures.

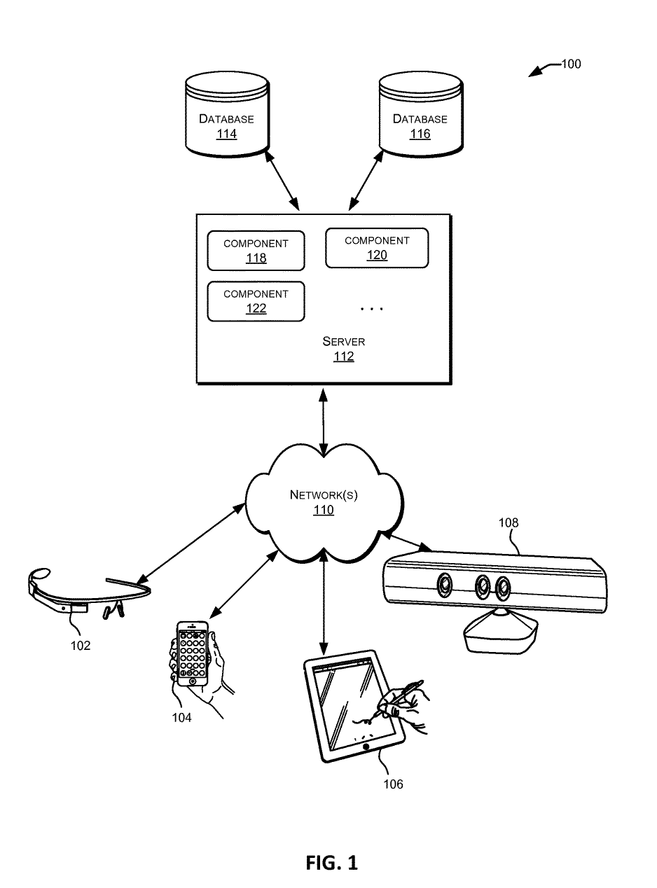

FIG. 1 is a block diagram illustrating components of an exemplary distributed system in which various embodiments of the present invention may be implemented. In the illustrated embodiment, distributed system 100 includes one or more client computing devices 102, 104, 106, and 108, which are configured to execute and operate a client application such as a web browser, proprietary client (e.g., Oracle Forms), or the like over one or more network(s) 110. Server 112 may be communicatively coupled with remote client computing devices 102, 104, 106, and 108 via network 110.

In various embodiments, server 112 may be adapted to run one or more services or software applications provided by one or more of the components of the system. In some embodiments, these services may be offered as web-based or cloud services or under a Software as a Service (SaaS) model to the users of client computing devices 102, 104, 106, and/or 108. Users operating client computing devices 102, 104, 106, and/or 108 may in turn utilize one or more client applications to interact with server 112 to utilize the services provided by these components.

In the configuration depicted in the figure, the software components 118, 120 and 122 of system 100 are shown as being implemented on server 112. In other embodiments, one or more of the components of system 100 and/or the services provided by these components may also be implemented by one or more of the client computing devices 102, 104, 106, and/or 108. Users operating the client computing devices may then utilize one or more client applications to use the services provided by these components. These components may be implemented in hardware, firmware, software, or combinations thereof. It should be appreciated that various different system configurations are possible, which may be different from distributed system 100. The embodiment shown in the figure is thus one example of a distributed system for implementing an embodiment system and is not intended to be limiting.

Client computing devices 102, 104, 106, and/or 108 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 102, 104, 106, and 108 may be any other electronic device, such as a thin-client computer, an Internet-enabled gaming system (e.g., a Microsoft Xbox gaming console with or without a Kinect® gesture input device), and/or a personal messaging device, capable of communicating over network(s) 110.

Although exemplary distributed system 100 is shown with four client computing devices, any number of client computing devices may be supported. Other devices, such as devices with sensors, etc., may interact with server 112.

Network(s) 110 in distributed system 100 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 110 can be a local area network (LAN), such as one based on Ethernet, Token-Ring and/or the like. Network(s) 110 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 112 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 112 may be adapted to run one or more services or software applications described in the foregoing disclosure. For example, server 112 may correspond to a server for performing processing described above according to an embodiment of the present disclosure.

Server 112 may run an operating system including any of those discussed above, as well as any commercially available server operating system. Server 112 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 112 may include one or more applications to analyze and consolidate data feeds and/or event updates received from users of client computing devices 102, 104, 106, and 108. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 112 may also include one or more applications to display the data feeds and/or real-time events via one or more display devices of client computing devices 102, 104, 106, and 108.

Distributed system 100 may also include one or more databases 114 and 116. Databases 114 and 116 may reside in a variety of locations. By way of example, one or more of databases 114 and 116 may reside on a non-transitory storage medium local to (and/or resident in) server 112. Alternatively, databases 114 and 116 may be remote from server 112 and in communication with server 112 via a network-based or dedicated connection. In one set of embodiments, databases 114 and 116 may reside in a storage-area network (SAN). Similarly, any necessary files for performing the functions attributed to server 112 may be stored locally on server 112 and/or remotely, as appropriate. In one set of embodiments, databases 114 and 116 may include relational databases, such as databases provided by Oracle, that are adapted to store, update, and retrieve data in response to SQL-formatted commands.

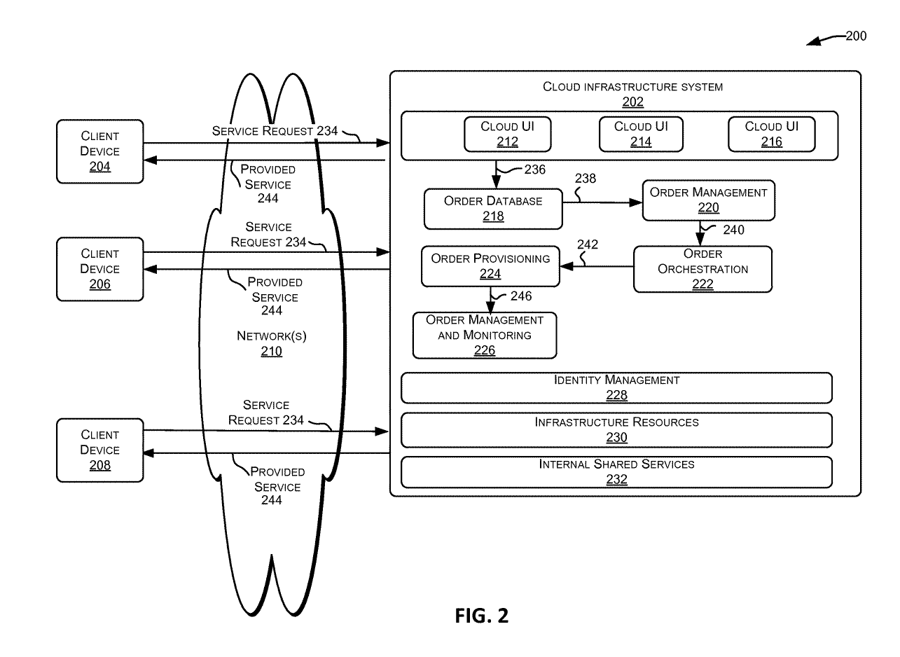

FIG. 2 is a block diagram illustrating components of a system environment by which services provided by embodiments of the present invention may be offered as cloud services. In the illustrated embodiment, system environment 200 includes one or more client computing devices 204, 206, and 208 that may be used by users to interact with a cloud infrastructure system 202 that provides cloud services. The client computing devices may be configured to operate a client application such as a web browser, a proprietary client application (e.g., Oracle Forms), or some other application, which may be used by a user of the client computing device to interact with cloud infrastructure system 202 to use services provided by cloud infrastructure system 202.

It should be appreciated that cloud infrastructure system 202 depicted in the figure may have other components than those depicted. Further, the embodiment shown in the figure is only one example of a cloud infrastructure system that may incorporate an embodiment of the invention. In some other embodiments, cloud infrastructure system 202 may have more or fewer components than shown in the figure, may combine two or more components, or may have a different configuration or arrangement of components.

Client computing devices 204, 206, and 208 may be devices similar to those described above for 102, 104, 106, and 108.

Although exemplary system environment 200 is shown with three client computing devices, any number of client computing devices may be supported. Other devices such as devices with sensors, etc. may interact with cloud infrastructure system 202.

Network(s) 210 may facilitate communications and exchange of data between clients 204, 206, and 208 and cloud infrastructure system 202. Each network may be any type of network familiar to those skilled in the art that can support data communications using any of a variety of commercially-available protocols, including those described above for network(s) 110.

Cloud infrastructure system 202 may comprise one or more computers and/or servers that may include those described above for server 112.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 202 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 202 may be adapted to automatically provision, manage and track a customer's subscription to services offered by cloud infrastructure system 202. Cloud infrastructure system 202 may provide the cloud services via different deployment models. For example, services may be provided under a public cloud model in which cloud infrastructure system 202 is owned by an organization selling cloud services (e.g., owned by Oracle) and the services are made available to the general public or different industry enterprises. As another example, services may be provided under a private cloud model in which cloud infrastructure system 202 is operated solely for a single organization and may provide services for one or more entities within the organization. The cloud services may also be provided under a community cloud model in which cloud infrastructure system 202 and the services provided by cloud infrastructure system 202 are shared by several organizations in a related community. The cloud services may also be provided under a hybrid cloud model, which is a combination of two or more different models.

In some embodiments, the services provided by cloud infrastructure system 202 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 202. Cloud infrastructure system 202 then performs processing to provide the services in the customer's subscription order.

In some embodiments, the services provided by cloud infrastructure system 202 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 202 may also include infrastructure resources 230 for providing the resources used to provide various services to customers of the cloud infrastructure system. In one embodiment, infrastructure resources 230 may include pre-integrated and optimized combinations of hardware, such as servers, storage, and networking resources to execute the services provided by the PaaS platform and the SaaS platform.

In some embodiments, resources in cloud infrastructure system 202 may be shared by multiple users and dynamically re-allocated per demand. Additionally, resources may be allocated to users in different time zones. For example, cloud infrastructure system 230 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 232 may be provided that are shared by different components or modules of cloud infrastructure system 202 and by the services provided by cloud infrastructure system 202. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 202 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 202, and the like.

In one embodiment, as depicted in the figure, cloud management functionality may be provided by one or more modules, such as an order management module 220, an order orchestration module 222, an order provisioning module 224, an order management and monitoring module 226, and an identity management module 228. These modules may include or be provided using one or more computers and/or servers, which may be general purpose computers, specialized server computers, server farms, server clusters, or any other appropriate arrangement and/or combination.

In exemplary operation 234, a customer using a client device, such as client device 204, 206 or 208, may interact with cloud infrastructure system 202 by requesting one or more services provided by cloud infrastructure system 202 and placing an order for a subscription for one or more services offered by cloud infrastructure system 202. In certain embodiments, the customer may access a cloud User Interface (UI), cloud UI 212, cloud UI 214 and/or cloud UI 216 and place a subscription order via these UIs. The order information received by cloud infrastructure system 202 in response to the customer placing an order may include information identifying the customer and one or more services offered by the cloud infrastructure system 202 that the customer intends to subscribe to.

After an order has been placed by the customer, the order information is received via the cloud UIs, 212, 214 and/or 216.

At operation 236, the order is stored in order database 218. Order database 218 can be one of several databases operated by cloud infrastructure system 218 and operated in conjunction with other system elements.

At operation 238, the order information is forwarded to an order management module 220. In some instances, order management module 220 may be configured to perform billing and accounting functions related to the order, such as verifying the order, and upon verification, booking the order.

At operation 240, information regarding the order is communicated to an order orchestration module 222. Order orchestration module 222 may utilize the order information to orchestrate the provisioning of services and resources for the order placed by the customer. In some instances, order orchestration module 222 may orchestrate the provisioning of resources to support the subscribed services using the services of order provisioning module 224.

In certain embodiments, order orchestration module 222 enables the management of business processes associated with each order and applies business logic to determine whether an order should proceed to provisioning. At operation 242, upon receiving an order for a new subscription, order orchestration module 222 sends a request to order provisioning module 224 to allocate resources and configure those resources needed to fulfill the subscription order. Order provisioning module 224 enables the allocation of resources for the services ordered by the customer. Order provisioning module 224 provides a level of abstraction between the cloud services provided by cloud infrastructure system 200 and the physical implementation layer that is used to provision the resources for providing the requested services. Order orchestration module 222 may thus be isolated from implementation details, such as whether or not services and resources are actually provisioned on the fly or pre-provisioned and only allocated/assigned upon request.

At operation 244, once the services and resources are provisioned, a notification of the provided service may be sent to customers on client devices 204, 206 and/or 208 by order provisioning module 224 of cloud infrastructure system 202.

At operation 246, the customer's subscription order may be managed and tracked by an order management and monitoring module 226. In some instances, order management and monitoring module 226 may be configured to collect usage statistics for the services in the subscription order, such as the amount of storage used, the amount data transferred, the number of users, and the amount of system up time and system down time.

In certain embodiments, cloud infrastructure system 200 may include an identity management module 228. Identity management module 228 may be configured to provide identity services, such as access management and authorization services in cloud infrastructure system 200. In some embodiments, identity management module 228 may control information about customers who wish to utilize the services provided by cloud infrastructure system 202. Such information can include information that authenticates the identities of such customers and information that describes which actions those customers are authorized to perform relative to various system resources (e.g., files, directories, applications, communication ports, memory segments, etc.) Identity management module 228 may also include the management of descriptive information about each customer and about how and by whom that descriptive information can be accessed and modified.

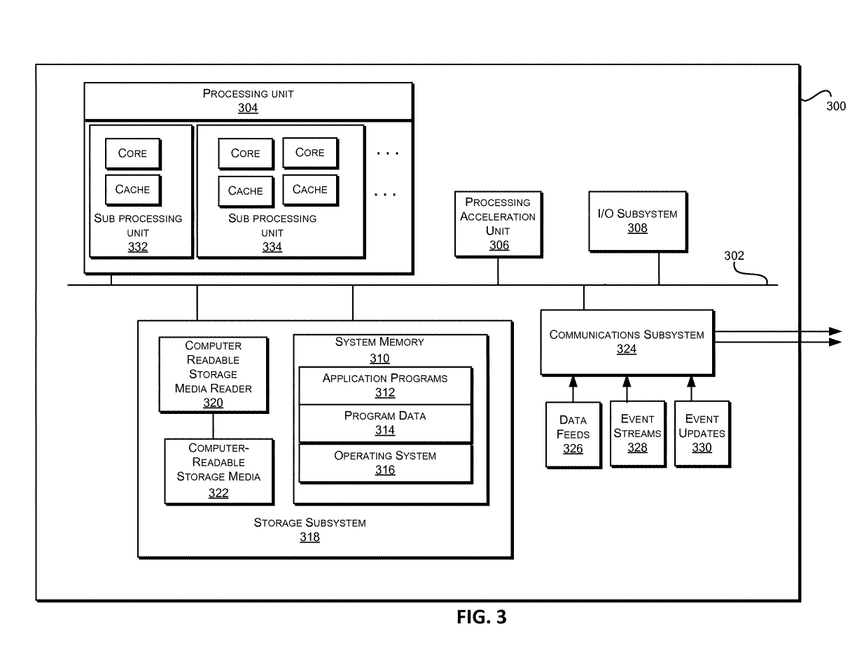

FIG. 3 is a block diagram illustrating an exemplary computer system in which embodiments of the present invention may be implemented. The system 300 may be used to implement any of the computer systems described above. As shown in the figure, computer system 300 includes a processing unit 304 that communicates with a number of peripheral subsystems via a bus subsystem 302. These peripheral subsystems may include a processing acceleration unit 306, an I/O subsystem 308, a storage subsystem 318 and a communications subsystem 324. Storage subsystem 318 includes tangible computer-readable storage media 322 and a system memory 310.

Bus subsystem 302 provides a mechanism for letting the various components and subsystems of computer system 300 communicate with each other as intended. Although bus subsystem 302 is shown schematically as a single bus, alternative embodiments of the bus subsystem may utilize multiple buses. Bus subsystem 302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 304, which can be implemented as one or more integrated circuits (e.g., a conventional microprocessor or microcontroller), controls the operation of computer system 300. One or more processors may be included in processing unit 304. These processors may include single core or multicore processors. In certain embodiments, processing unit 304 may be implemented as one or more independent processing units 332 and/or 334 with single or multicore processors included in each processing unit. In other embodiments, processing unit 304 may also be implemented as a quad-core processing unit formed by integrating two dual-core processors into a single chip.

In various embodiments, processing unit 304 can execute a variety of programs in response to program code and can maintain multiple concurrently executing programs or processes. At any given time, some or all of the program code to be executed can be resident in processor(s) 304 and/or in storage subsystem 318. Through suitable programming, processor(s) 304 can provide various functionalities described above. Computer system 300 may additionally include a processing acceleration unit 306, which can include a digital signal processor (DSP), a special-purpose processor, and/or the like.

I/O subsystem 308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 300 may comprise a storage subsystem 318 that comprises software elements, shown as being currently located within a system memory 310. System memory 310 may store program instructions that are loadable and executable on processing unit 304, as well as data generated during the execution of these programs.

Depending on the configuration and type of computer system 300, system memory 310 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 304. In some implementations, system memory 310 may include multiple different types of memory, such as static random access memory (SRAM) or dynamic random access memory (DRAM). In some implementations, a basic input/output system (BIOS), containing the basic routines that help to transfer information between elements within computer system 300, such as during start-up, may typically be stored in the ROM. By way of example, and not limitation, system memory 310 also illustrates application programs 312, which may include client applications, Web browsers, mid-tier applications, relational database management systems (RDBMS), etc., program data 314, and an operating system 316. By way of example, operating system 316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 318 may also provide a tangible computer-readable storage medium for storing the basic programming and data constructs that provide the functionality of some embodiments. Software (programs, code modules, instructions) that when executed by a processor provide the functionality described above may be stored in storage subsystem 318. These software modules or instructions may be executed by processing unit 304. Storage subsystem 318 may also provide a repository for storing data used in accordance with the present invention.

Storage subsystem 300 may also include a computer-readable storage media reader 320 that can further be connected to computer-readable storage media 322. Together and, optionally, in combination with system memory 310, computer-readable storage media 322 may comprehensively represent remote, local, fixed, and/or removable storage devices plus storage media for temporarily and/or more permanently containing, storing, transmitting, and retrieving computer-readable information.

Computer-readable storage media 322 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 300.

By way of example, computer-readable storage media 322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 322 may include, but is not limited to, Zip® drives, flash memory cards, universal serial bus (USB) flash drives, secure digital (SD) cards, DVD disks, digital video tape, and the like. Computer-readable storage media 322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 300.

Communications subsystem 324 provides an interface to other computer systems and networks. Communications subsystem 324 serves as an interface for receiving data from and transmitting data to other systems from computer system 300. For example, communications subsystem 324 may enable computer system 300 to connect to one or more devices via the Internet. In some embodiments communications subsystem 324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 324 can provide wired network connectivity (e.g., Ethernet) in addition to or instead of a wireless interface.

In some embodiments, communications subsystem 324 may also receive input communication in the form of structured and/or unstructured data feeds 326, event streams 328, event updates 330, and the like on behalf of one or more users who may use computer system 300.

By way of example, communications subsystem 324 may be configured to receive data feeds 326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 324 may also be configured to receive data in the form of continuous data streams, which may include event streams 328 of real-time events and/or event updates 330, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 324 may also be configured to output the structured and/or unstructured data feeds 326, event streams 328, event updates 330, and the like to one or more databases that may be in communication with one or more streaming data source computers coupled to computer system 300.

Computer system 300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

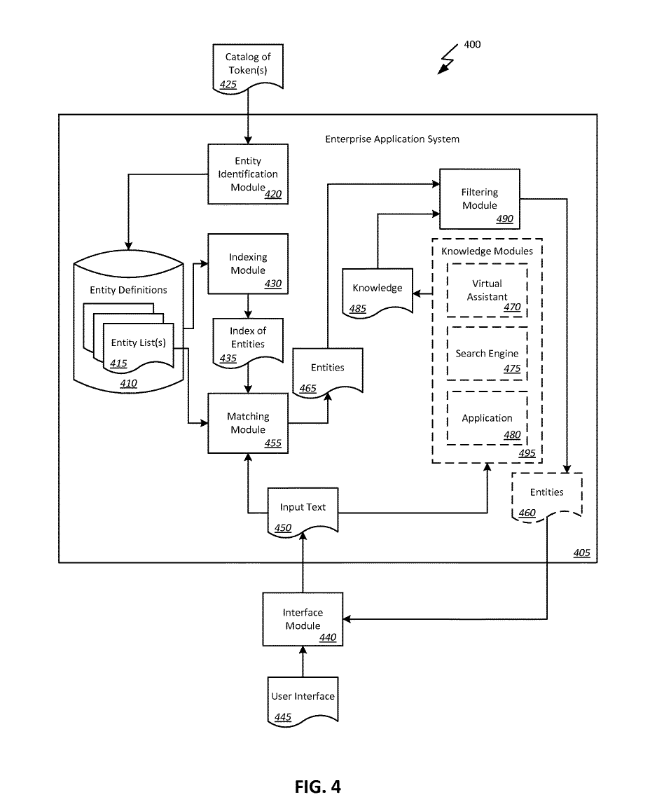

FIG. 4 is a block diagram illustrating, at a high-level, functional components of a system for performing comprehensive, fuzzy matching of tokens from a text string to one or more lists according to one embodiment of the present invention. As illustrated in this example, the system 400 can include an enterprise application system 405 such as a server executing one or more enterprise applications including but not limited to a Customer Relationship Management (CRM) application, a Human Capital Management (HCM) application, an Enterprise Resource Planning (ERP) application, a Supply Chain Management (SCM) application, a project management application, various one or more different financial and/or accounting applications, one or more e-commerce applications, etc. However, it should be noted that, while described in the context of or with reference to an enterprise application and/or enterprise application system 405, embodiments of the present invention are not limited to such implementations. Rather, embodiments described herein can be implemented in a variety of different applications and/or systems of different types.

As introduced above, embodiments of the present invention provide for matching of tokens from a text string, such as an input string received from a user, to one or more lists. To do so, embodiments can comprise storing a plurality of entity definitions 410 comprising one or more lists of entities 415. Generally speaking, an entity definition can be considered the name of the list and the entities belonging to the list, i.e., under the entity definition, can be considered particular instances of that definition. For example, “Mobile Phones” can be an entity definition and “Samsam S4” can be an entity in the list for this definition. An entity or “named entity” as it is often referred to, can be a linguistic element (in this case textual element) that refers to something particular like among others, persons, products, organizations, companies, locations but also expressions of times, quantities, etc.

The lists of entities 415 can be generated by an entity identification module 420 based on a pre-defined catalog of tokens 425. For example, the catalog of tokens 425 can comprise a list of products and/or services supported by a CRM application. In another example, it may represent a catalog of goods available through an e-commerce application. Generally speaking, the entity identification module 420 can parse this catalog 425, identify each token, e.g., product name etc., generate a corresponding entity for each token, and add the generated token to one or more lists 415 in the entity definitions 410. Product names can consist of multiple tokens like “Samsam S4” (2 tokens: “Samsam” and “S4”). In such a case, the entity identification module 420 might generate extra information on the type of linguistic element the entity is. For instance “Samsam S4” could be labeled as a PropN (proper name), whereas “San Antonio” might be labeled as NLoc (noun+location).

According to one embodiment, an indexing module 430 of the enterprise application system 405 can generate an index 435 of the one or more lists of entities. The index 435 can map each token of the catalog 425 to entity definitions in the one or more entity lists 415. For example, given a catalog of entity definitions such as:

```
{“Catalog”:
    {“Mobile Phones”:
        {“Samsam S4”; “Samsam Galaxy S3”; “iFuse 5C”}
    }
    {“Companies”:
        {“Alto Nobel B.V.”, “Philbert Electronics”; “Air Germany”;
        “Samsam”}
    }
...}
```

An index can be generated mapping each token in the catalog to the list of entities that contain it. For instance the token “Samsam” is present in 2 entities in one under “Mobile Phones” and one under “Companies”.

At some point thereafter, an input text string can be received. For example, the enterprise application system 405 can include an interface module 440 providing a user interface 445 such as one or more web pages through which a user can enter a query or other string. The string can comprise a plurality of characters forming one or more input tokens. The received input text string 450 can be provided by the interface module to a matching module of the enterprise application system 405. The one or more input tokens in the input text string 450 can be identified by the matching module 455 and a plurality of likely entities corresponding to the input text string 450 can be determined by the matching module 455 based on the identified one or more input tokens and the index 435 of the one or more lists of entities 415.

In use, when a user asks a query to the enterprise application system 405, each token in the query can be regarded as a possible reference to an existing entity in the lists of entities 415. So, for each token in the input text string 450 the matching module 455 can check whether it is referenced in the index 435. According to one embodiment, the matching module 455 may be adapted to ignore certain kind of tokens/words, that can be defined as a stoplist of, for instance, very frequent words (be, and, the, . . . ) plus possibly additional user-defined terms (eventual vertical specific terms). Furthermore the tokens are not necessarily looked up strictly but might be looked up using spelling correction (say using edit distance: delete/add/swap letters).When all tokens in the input text string 450 have been checked, the matching module 455 can retrieve the candidate entities from the lists of entities 415 identified in the index 430. If two or more retrieved “entity tokens” are neighbors in the user input text string 450 their lists can be intersected by the matching module 455. The resulting intersection can be the actual list of entity candidates. If the intersection is void, then the matching module 455 can return the previous two lists of candidate entities. The matching module 455 can then search for maximal windows of non-empty intersections between subsequent tokens and return the most likely entities 465 selected for sequences of tokens. Take for instance the following user query: “I want to buy a Samsam phone.” Based on the example above, the only “entity token” in this case is “Samsam.” Knowledge module 495 or set of processes such as a virtual assistant 470, search engine 475, application 480, etc. can recognize the topic of the query “buying a mobile phone” and therefore restrict the ambiguity of the entity token to the “Mobile Phones” list. This identified knowledge 485 and the candidate entities 465 can be provided to a filtering module 490. The filtering module 490 can then restrict the candidates to the two entities “Samsam S4” and “Samsam Galaxy S3” and eliminate the candidate “Samsam” under “companies.” In some cases, the matching module 455 and interface module 440 can then present those entities 460 back to the user, e.g., through the user interface 440, to trigger a choice. Additionally or alternatively, perhaps after a choice is selected, the matching module 455 can provide the entities 465 to one or more other processes or elements of the enterprise application system 405 such as the virtual assistant 470, search engine 475, application 480, etc.

Stated another way, determining the plurality of likely entities corresponding to the text string can comprise determining by the matching module 455 whether a token of the one or more input tokens in the input text string 450 appears in the index 435 of the one or more entities. In response to determining the token of the one or more input tokens in the input text string 450 appears in the index 435 of the one or more entities, candidate entities can be retrieved by the matching module 455 from the one or more lists of entities 415 based on the index 435. Determining whether a token of the one or more input tokens in the input text string 450 appears in the index 435 of the one or more entities and retrieving candidate entities from the one or more lists of entities 415 based on the index 435 can be repeated by the matching module 455 for each identified one or more input tokens in the input text string 450.

Once all the identified input tokens have been checked, a determination can be made by the matching module 455 as to whether two or more tokens of the input tokens are neighboring tokens. In response to determining whether two or more tokens of the input tokens are neighboring tokens, an intersection of the retrieved candidate entities for the two or more tokens of the input tokens can be determined by the matching module 455 and result entities 465 can be defined by the matching module 455 as the intersection of the retrieved candidate entities for the two or more tokens of the input tokens. In response to determining whether two or more tokens of the input tokens are not neighboring tokens, result entities 465 can be defined by the matching module 455 as the retrieved candidate entities for the two or more tokens of the input tokens.

Determining the plurality of likely entities 465 corresponding to the input text string 450 can further comprise score, by the matching module 455, the candidate entities using a similarity measure. The similarity measure can return likelihood values for one or more candidate entities by comparing each candidate against the text stream or by comparing against one or more maximal windows of non-empty intersections within the result tokens. The values can be computed directly or by aggregating different similarity measures in order to cover a broad range of criteria. One or more of the most likely entities corresponding to the text string can then be selected 565 based on the similarity measure and provided 580 for further processing. The most likely entities 460 corresponding to the text string can then be presented by the matching module 455 for selection and a selection of one or more of the presented most likely entities can be received. For example, the likely entities 460 can be presented by the interface module 440 through the user interface 445 for selection by a user. One or more of the most likely entities 465 corresponding to the text string can then be provided for further processing by a virtual assistant 470, search engine 475, application 480, and/or one or more other processes or elements.

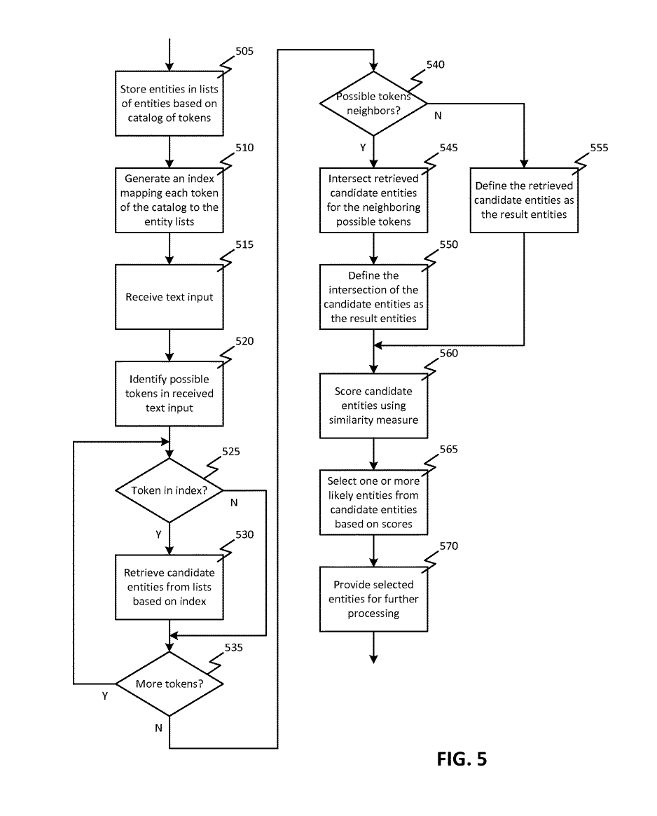

FIG. 5 is a flowchart illustrating a process for performing comprehensive, fuzzy matching of tokens from a text string to one or more lists according to one embodiment of the present invention. As illustrated in this example, matching tokens from a text string to one or more lists can begin with storing 505 a plurality of entity definitions in one or more lists of entities based on a catalog of tokens and generating 510 an index of the one or more lists of entities. The index can map each token of the catalog to entity definitions in the one or more lists. At some point thereafter, the text string can be received 515. The text string can comprise a plurality of characters forming one or more input tokens. The one or more input tokens in the text string can be identified 520 and a plurality of likely entities corresponding to the text string can be determined 525-565 based on the identified one or more input tokens and the index of the one or more lists of entities.

More specifically, determining 525-565 the plurality of likely entities corresponding to the text string can further comprise determining 525 whether a token of the one or more input tokens appears in the index of the one or more entities. In response to determining 525 the token of the one or more input tokens appears in the index of the one or more entities, candidate entities can be retrieved 530 from the one or more lists of entities based on the index. Determining 525 whether a token of the one or more input tokens appears in the index of the one or more entities and retrieving 530 candidate entities from the one or more lists of entities based on the index can be repeated 535 for each identified one or more input tokens.

Once all the identified input tokens have been checked 535, a determination 540 can be made as to whether two tokens of the input tokens are neighboring tokens. In response to determining 540 two tokens of the input tokens are neighboring tokens, an intersection of the retrieved candidate entities for the two tokens of the input tokens can be determined 545 and result entities can be defined 550 as the intersection of the retrieved candidate entities for the two tokens of the input tokens. In response to determining 540 two tokens of the input tokens are not neighboring tokens, result entities can be defined 555 as the retrieved candidate entities for the two tokens of the input tokens.

A similarity measure can be used to score 560 the candidate entities. The similarity measure can return likelihood values for one or more candidate entities by comparing each candidate against the text stream or by comparing against one or more maximal windows of non-empty intersections within the result tokens. The values can be computed directly or by aggregating different similarity measures in order to cover a broad range of criteria. One or more of the most likely entities corresponding to the text string can then be selected 565 based on the similarity measure and provided 580 for further processing. Embodiments can use multiple different similarity criteria including, but not limited to, the number of common words, the sum of positions of these words, the difference in length, the number of stop words, the number of numbers that appear etc., and we can aggregate them either in the form of a weighted sum or as a non-linear combination to obtain a final similarity value. This value may indicate likelihood, but to have uniform values across different instances (different lengths of the input and different database of entities), the value can be normalized in a restricted interval, e.g., between 0 and 1. According to one embodiment and in addition to this formal similarity between two sequences of one or more tokens, the overall degree of spelling errors that the input text may have can be determined. The final value can be used to rank the entities based on their likelihood (e.g. the more a candidate entity is similar to the tokens in the maximal window of intersections, the more likely it is to reflect the user's intent). Once ranked or scored, the first most likely entities, not necessarily all of them, can be returned ordered by their similarity.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums or memory devices, such as CD-ROMs or other type of optical disks, floppy diskettes, ROMs, RAMs, EPROMs, EEPROMs, magnetic or optical cards, flash memory, or other types of machine-readable mediums or memory devices suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for matching tokens from a text string to one or more lists, the method comprising:
storing a plurality of entity definitions in one or more lists of entities based on a catalog of tokens;
generating an index of the one or more lists of entities, the index mapping each token of the catalog to entity definitions in the one or more lists;
receiving the text string, the text string comprising a plurality of characters forming one or more input tokens;
identifying the one or more input tokens in the text string; and
determining a plurality of likely entities corresponding to the text string based on the identified one or more input tokens and the index of the one or more lists of entities.

2. The method of claim 1, wherein determining the plurality of likely entities corresponding to the text string further comprises:
determining whether a token of the one or more input tokens appears in the index of the one or more entities;
in response to determining the token of the one or more input tokens appears in the index of the one or more entities, retrieving candidate entities from the one or more lists of entities based on the index; and
repeating said determining whether a token of the one or more input tokens appears in the index of the one or more entities and retrieving candidate entities from the one or more lists of entities based on the index for each identified one or more input tokens.

3. The method of claim 2, wherein determining the plurality of likely entities corresponding to the text string further comprises:
determining whether two or more tokens of the input tokens are neighboring tokens; and
in response to determining two tokens of the input tokens are neighboring tokens, determining an intersection of the retrieved candidate entities for the two tokens of the input tokens and defining result entities as the intersection of the retrieved candidate entities for the two tokens of the input tokens.

4. The method of claim 3, further comprising, in response to determining two tokens of the input tokens are not neighboring tokens, defining result entities as the retrieved candidate entities for the two tokens of the input tokens.

5. The method of claim 4, wherein determining the plurality of likely entities corresponding to the text string further comprises:
scoring the retrieved candidate entities using a similarity measure for each candidate entity; and
selecting one or more likely entities from the scored candidate entities based on the score of each candidate entity.

6. The method of claim 5, wherein scoring the retrieved candidate entities using a similarity measure for each candidate entity comprises comparing each candidate entity against the text string or comparing each candidate entity against one or more maximal windows of non-empty intersections within tokens of the candidate entities.

7. The method of claim 5, further comprising providing the one or more likely entities corresponding to the text string for further processing.

8. A system comprising:
a processor; and
a memory coupled with and readable by the processor and storing therein a set of instructions which, when executed by the processor causes the processor to match tokens from a text string to one or more lists by:
storing a plurality of entity definitions in one or more lists of entities based on a catalog of tokens;
generating an index of the one or more lists of entities, the index mapping each token of the catalog to entity definitions in the one or more lists;
receiving the text string, the text string comprising a plurality of characters forming one or more input tokens;
identifying the one or more input tokens in the text string; and
determining a plurality of likely entities corresponding to the text string based on the identified one or more input tokens and the index of the one or more lists of entities.

9. The system of claim 8, wherein determining the plurality of likely entities corresponding to the text string further comprises:
determining whether a token of the one or more input tokens appears in the index of the one or more entities;
in response to determining the token of the one or more input tokens appears in the index of the one or more entities, retrieving candidate entities from the one or more lists of entities based on the index; and
repeating said determining whether a token of the one or more input tokens appears in the index of the one or more entities and retrieving candidate entities from the one or more lists of entities based on the index for each identified one or more input tokens.

10. The system of claim 9, wherein determining the plurality of likely entities corresponding to the text string further comprises:
determining whether two or more tokens of the input tokens are neighboring tokens; and
in response to determining two tokens of the input tokens are neighboring tokens, determining an intersection of the retrieved candidate entities for the two tokens of the input tokens and defining result entities as the intersection of the retrieved candidate entities for the two tokens of the input tokens.

11. The system of claim 10, further comprising, in response to determining two tokens of the input tokens are not neighboring tokens, defining result entities as the retrieved candidate entities for the two tokens of the input tokens.

12. The system of claim 11, wherein determining the plurality of likely entities corresponding to the text string further comprises:
scoring the retrieved candidate entities using a similarity measure for each candidate entity; and
selecting one or more likely entities from the scored candidate entities based on the score of each candidate entity.

13. The system of claim 12, wherein scoring the retrieved candidate entities using a similarity measure for each candidate entity comprises comparing each candidate entity against the text string or comparing each candidate entity against one or more maximal windows of non-empty intersections within tokens of the candidate entities.

14. The system of claim 12, further comprising providing the one or more likely entities corresponding to the text string for further processing.

15. A computer-readable memory comprising a set of instructions stored therein which, when executed by a processor, causes the processor to match tokens from a text string to one or more lists by:
storing a plurality of entity definitions in one or more lists of entities based on a catalog of tokens;
generating an index of the one or more lists of entities, the index mapping each token of the catalog to entity definitions in the one or more lists;
receiving the text string, the text string comprising a plurality of characters forming one or more input tokens;
identifying the one or more input tokens in the text string; and
determining a plurality of likely entities corresponding to the text string based on the identified one or more input tokens and the index of the one or more lists of entities.

16. The computer-readable memory of claim 15, wherein determining the plurality of likely entities corresponding to the text string further comprises:
determining whether a token of the one or more input tokens appears in the index of the one or more entities;
in response to determining the token of the one or more input tokens appears in the index of the one or more entities, retrieving candidate entities from the one or more lists of entities based on the index; and
repeating said determining whether a token of the one or more input tokens appears in the index of the one or more entities and retrieving candidate entities from the one or more lists of entities based on the index for each identified one or more input tokens.

17. The computer-readable memory of claim 16, wherein determining the plurality of likely entities corresponding to the text string further comprises:
determining whether two or more tokens of the input tokens are neighboring tokens; and
in response to determining two tokens of the input tokens are neighboring tokens, determining an intersection of the retrieved candidate entities for the two tokens of the input tokens and defining result entities as the intersection of the retrieved candidate entities for the two tokens of the input tokens.

18. The computer-readable memory of claim 17, further comprising, in response to determining two tokens of the input tokens are not neighboring tokens, defining result entities as the retrieved candidate entities for the two tokens of the input tokens.

19. The computer-readable memory of claim 18, wherein determining the plurality of likely entities corresponding to the text string further comprises:
scoring the retrieved candidate entities using a similarity measure for each candidate entity;
selecting one or more likely entities from the scored candidate entities based on the score of each candidate entity; and
providing the one or more likely entities corresponding to the text string for further processing.

20. The computer-readable memory of claim 19, wherein scoring the retrieved candidate entities using a similarity measure for each candidate entity comprises comparing each candidate entity against the text string or comparing each candidate entity against one or more maximal windows of non-empty intersections within tokens of the candidate entities.
